(19) United States
(12) Patent Application Publication
(10) Pub. No.: US 2015/0373954 A1
(43) Pub. Date: Dec. 31, 2015

(54) WATER TREATMENT EQUIPMENT FOR RECIRCULATING AQUACULTURE

(71) Applicant: CHI-TSE KUO, Taichung City (TW)

(72) Inventor: CHI-TSE KUO, Taichung City (TW)

(21) Appl. No.: 14/317,803

(22) Filed: Jun. 27, 2014

(51) Int. Cl. A01K 63/04

(52) U.S. Cl. CPC A01K 63/045; A01K 63/042

(57) ABSTRACT

Water treatment equipment for recirculating aquaculture contains: at least one aquaculture tank, an aeration unit, at least one water circulating tank, a plurality of membrane filtering units and a water returning unit. Each aquaculture tank includes plural connecting plate units and a flowing cup; the aeration unit includes a plurality of air supply pipes. Each water circulating tank includes a nitration reacting chamber and an accommodating chamber, and the nitration reacting chamber has a flow tube outwardly extending to the flowing cup and a nitrifying bacteria layer fixed therein. Each membrane filtering unit is a circularly flat membrane and includes a water pipe and plural disc-shaped film bags, wherein each film bag has two filtering films communicating with the water pipe; and the water returning unit is fixed outside each aquaculture tank and includes a pump and a water return tube.

### BACKGROUND OF THE INVENTION

1. Technical Field

The present invention relates to water treatment equipment for aquaculture, and more particularly to water treatment equipment for recirculating aquaculture which enhances aquaculture density and survival rate, reduces configuration space, and is cleaned easily.

2. Description of Related Art

A conventional aquaculture in a fish pond is limited because of land subsidence resulting from over-pumping of groundwater, so closed recirculating aquaculture system is developed. For example, such an aquaculture system contains an aquaculture tank in which aquaculture water is fed, an aeration apparatus fixed in the tank to supply oxygen, and a discharging tube mounted on a bottom end thereof and connecting with a water purification device, such that the aquaculture water is filtered by the water purification device and flows back to the aquaculture tank, thus recycling the aquaculture water effectively.

However, the recirculating aquaculture system still has defects as follows:

1. Baits and feeding are fed into the aquaculture tank, residual feeding and excreta deposit in the aquaculture tank accordingly to increase nitrite and ammonia concentration, thus eutrophicating and polluting the aquaculture water.

2. The aquaculture tank is made of cement or stainless steel, so it is in a fixed size and cannot be portable.

3. The aquaculture tank has to be cleaned periodically so as to prevent breeding of bacteria and algae, but it cannot be removed for easy cleaning.

4. The water purification device has to match with multi-stage processing, for instance, filtering solid granules with a large diameter in a sand filtration manner, eliminating ammonia and organic in aquaculture water in a biological treatment manner, filtering suspended particles and sludge in the aquaculture water by using microporous material, adding medicinal agent to sterilize bacteria, flowing the aquaculture water to a salt groove to adjust PH value, and then circulating the aquaculture water into the t aquaculture tank after aeration. Therefore, the water purification device occupies large configuration space and causes expensive using cost.

5. The filtering material has to be replaced regularly to have high replacement cost.

The present invention has arisen to mitigate and/or obviate the afore-described disadvantages.

### SUMMARY OF THE INVENTION

The primary object of the present invention is to provide water treatment equipment for recirculating aquaculture which supplies aeration and sufficient dissolved oxygen in each aquaculture tank, and floats residual feeding and excreta upwardly so that the residual feeding and the excreta further flow out of each aquaculture tank, thus enhancing aquaculture density and survival rate.

Further object of the present invention is to provide water treatment equipment for recirculating aquaculture in which each aquaculture tank is connected quickly by the plural connecting plate units so that each aquaculture tank is assembled quickly and is portable and cleaned easily.

Another object of the present invention is to provide treatment equipment for recirculating aquaculture in which each aquaculture tank is integrated with biological treatment and membrane filtering device to reduce a configuration space of the water treatment equipment.

To obtain the above objectives, treatment equipment for recirculating aquaculture provided by the present invention contains: at least one aquaculture tank, an aeration unit, at least one water circulating tank, a plurality of membrane filtering units and a water returning unit.

Each aquaculture tank is removable and includes plural connecting plate units connected together to form an octagonal hollow tank, and each aquaculture tank also includes a flowing cup.

The aeration unit includes a plurality of air supply pipes arranged on a bottom end of each aquaculture tank to input exterior air into water for having aeration, maintaining dissolved oxygen and producing tiny air bubbles, such that residual feeding and excreta in each aquaculture tank float upwardly and then flow out of each aquaculture tank via the flowing cup.

Each water circulating tank is removable and is disposed on a first side of each aquaculture tank proximate to the flowing cup, and each water circulating tank includes a nitration reacting chamber defined on a bottom end thereof and an accommodating chamber arranged above the nitration reacting chamber, the nitration reacting chamber has a flow tube outwardly extending to the flowing cup and a nitrifying bacteria layer fixed therein, such that the water flows into the nitration reacting chamber through the flow tube to be nitrified/denitrified by the nitrifying bacteria layer, thus removing ammonia, nitrate and nitrite in the water.

The plurality of membrane filtering units are arranged in the accommodating chamber, and each membrane filtering unit is a circularly flat membrane and includes a water pipe and plural disc-shaped film bags tightly inserted on the water pipe, wherein each film bag has two filtering films communicating with the water pipe.

The water returning unit is fixed outside each aquaculture tank and includes a pump joined with one end of the water pipe and a water return tube connected with an outlet end of the pump, the water return tube extends to each aquaculture tank, and the water is pumped backed to each aquaculture tank via the water pipe and the water return tube, thus forming recycled water.

### BRIEF DESCRIPTION OF THE DRAWINGS

FIG. 1 is a diagram showing the assembly of water treatment equipment for recirculating aquaculture according to a preferred embodiment of the present invention.

FIG. 2 is a top plan view showing the assembly of an aquaculture tank and a water circulating tank of the water treatment equipment for the recirculating aquaculture according to the preferred embodiment of the present invention.

FIG. 3 is a cross sectional view showing the assembly of a part of a connecting plate unit of the aquaculture tank according to the preferred embodiment of the present invention.

FIG. 4 is an amplified cross sectional view of a portion marked by an imaginary line of FIG. 3.

FIG. 5 is a perspective view showing the assembly of the aquaculture tank and the water circulating tank of the water treatment equipment for the recirculating aquaculture according to the preferred embodiment of the present invention.

FIG. 6 is a cross sectional view showing the assembly of the water circulating tank of the water treatment equipment for the recirculating aquaculture according to the preferred embodiment of the present invention.

FIG. 7 is a cross sectional view showing the assembly of a sterilization unit of the water treatment equipment for the recirculating aquaculture according to the preferred embodiment of the present invention.

FIG. 8 is a cross sectional view showing the assembly of a membrane filtering unit of the water treatment equipment for the recirculating aquaculture according to the preferred embodiment of the present invention.

FIG. 9 is a cross sectional view showing the assembly of two film bags of the water treatment equipment for the recirculating aquaculture according to the preferred embodiment of the present invention.

FIG. 10 is a diagram showing plural aquaculture tanks of the water treatment equipment for the recirculating aquaculture being connected together according to the preferred embodiment of the present invention.

### DETAILED DESCRIPTION OF THE PREFERRED EMBODIMENTS

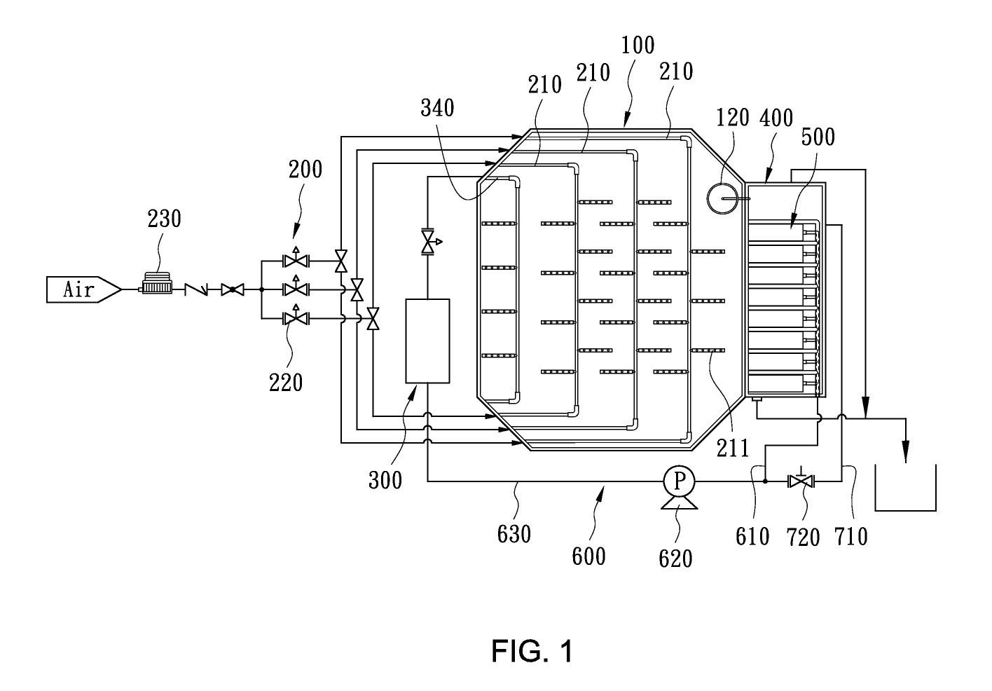

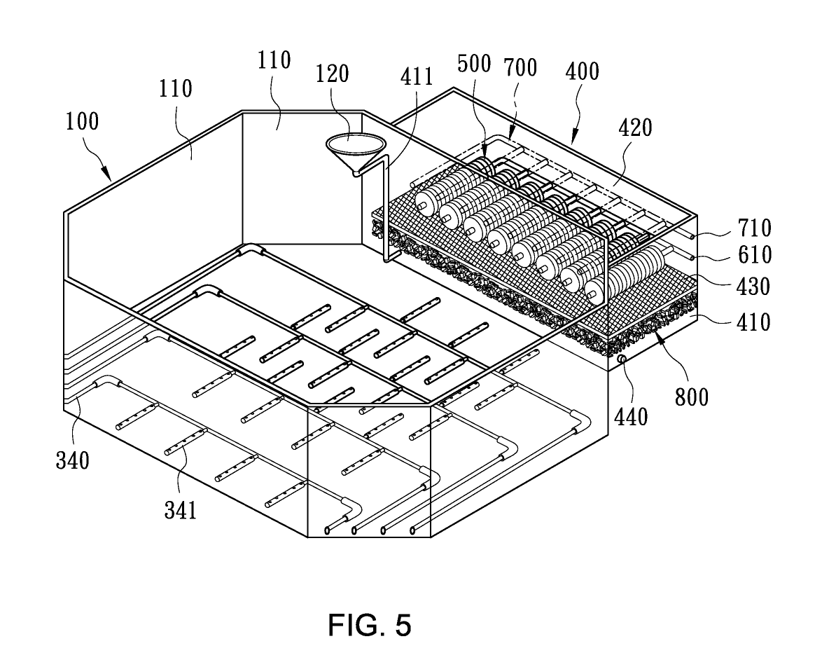

With reference to FIGS. 1 and 5, water treatment equipment for recirculating aquaculture according to a preferred embodiment of the present invention comprises: at least one aquaculture tank 100, an aeration unit 200, a sterilization unit 300, at least one water circulating tank 400, a plurality of membrane filtering units 500, a water returning unit 600, and a spraying unit 700.

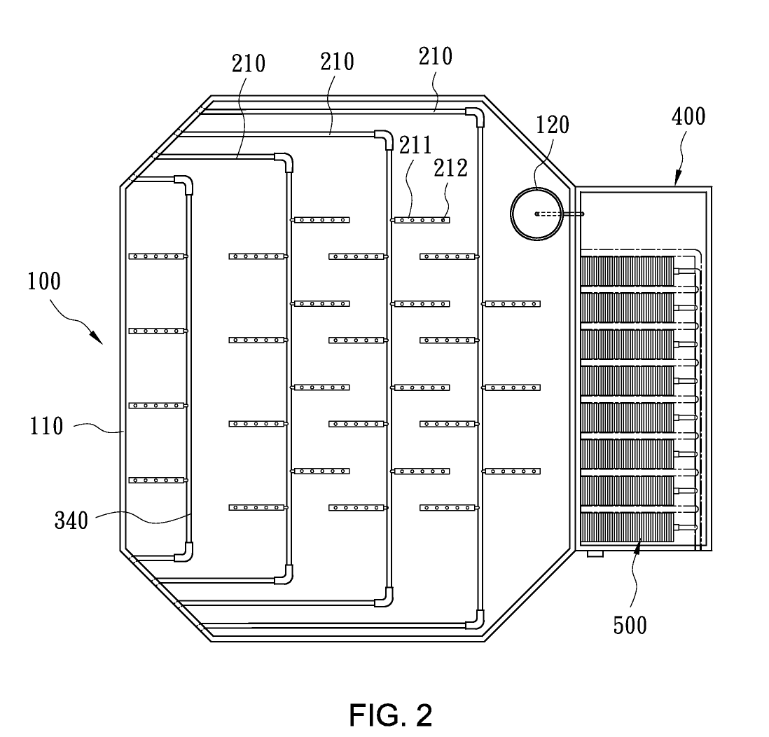

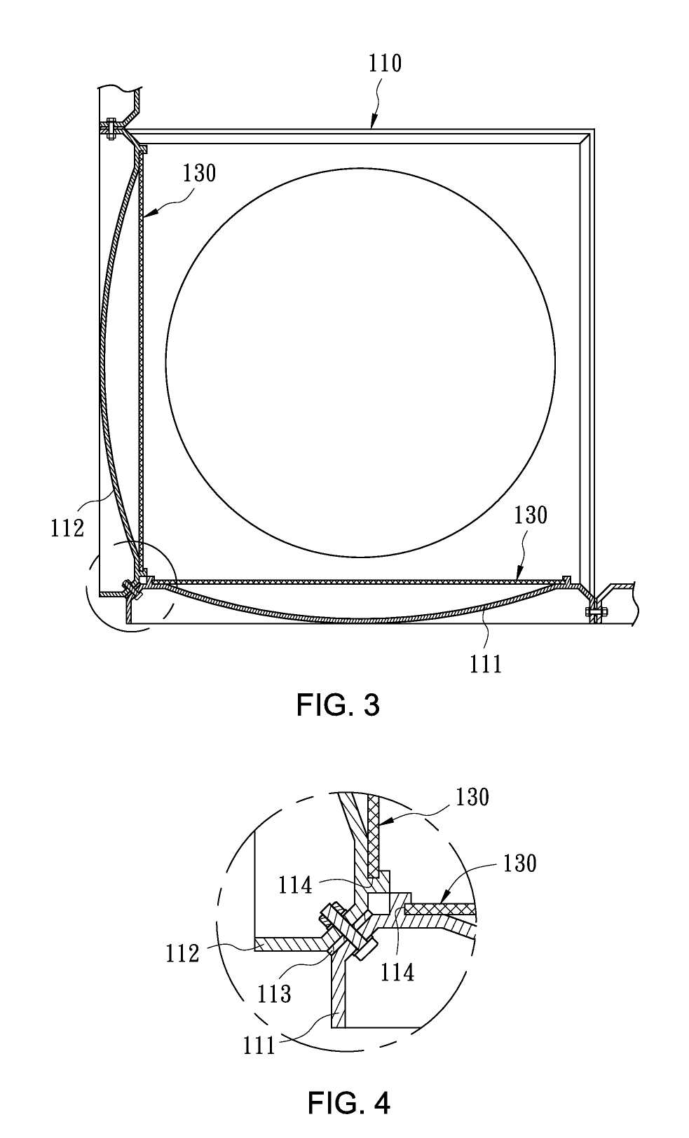

Referring to FIGS. 2 to 4, each aquaculture tank 100 is removable and is employed to hold treated aquaculture water. Each aquaculture tank 100 includes plural connecting plate units 110 connected together to form an octagonal hollow tank, such that the treated aquaculture water flows circulatively in each aquaculture tank 100. To lower mold manufacturing cost, each connecting plate unit 110 has a first plate 111 and a second plate 112 which are manufactured in a predetermined proportion and are coupled together. Each connecting plate unit 110 also includes a watertight strip 113 defined between the first plate 111 and the second plate 112 to prevent water leakage. In this embodiment, each of the first plate 111 and the second plate 112 is hollow and is made of glass fiber-reinforced polymer (FRP) material to reduce its weight, thus obtaining easy delivery, assembly and disassembly. Preferably, each aquaculture tank 100 also includes a funnel-shaped flowing cup 120 adjacent to one of the plural connecting plate units 110, and a height of the flowing cup 120 is higher than a level of the treated aquaculture water.

Each of the first plate 111 and the second plate 112 has a retaining slot 114 formed on an inner wall thereof to retain an antibacterial material layer 130, and the antibacterial material layer 130 is a stainless steel mesh made of silver, copper, cobalt and titanium dioxide (TiO2) to reinforce impact strength and to enhance antimicrobial effect and corrosion resistance. Preferably, the antibacterial material layer 130 is removed from the retaining slot 114 easily for cleaning.

As shown in FIGS. 1 and 2, the aeration unit 200 includes a plurality of air supply pipes 210 arranged on a bottom end of each aquaculture tank 100, plural air control valves 220 communicating with the plurality of air supply pipes 210, and a blower 230 coupled with the plural air control valves 220. In this embodiment, there are three air supply pipes 210 in a horseshoe shape parallelly arranged on the bottom end of each aquaculture tank 100, and each air supply pipe 210 has plural branch pipes 211 extending outwardly from two sides thereof, and each branch pipe 211 has a plurality of air holes 212, hence each aquaculture tank 100 includes an air supply structure formed on the bottom end thereof. Furthermore, each air control valve 220 is joined with an external water detecting system (not shown) to adjust air flow from each air supply pipe 210, thus supplying sufficient dissolved oxygen in each aquaculture tank 100.

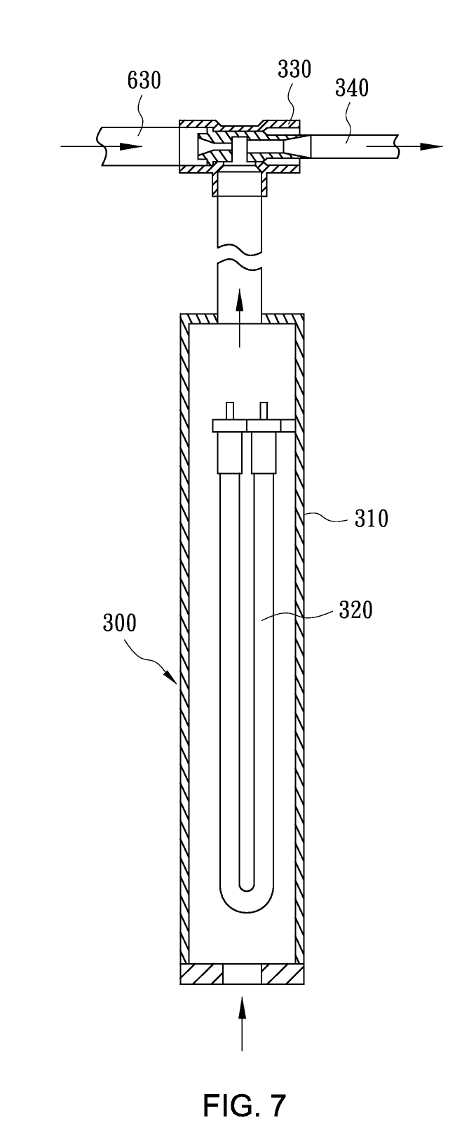

As illustrated in FIGS. 1 and 7, the sterilization unit 300 is mounted on a first side of each aquaculture tank 100 and includes a housing 310, at least one UV light source 320 fixed in the housing 310, a suction valve 330 connecting with the at least one UV light source 321, and an ozone supply tube 340 extending into the bottom end of each aquaculture tank 100. In this embodiment, the ozone supply tube 340 has plural branch tubes 341 (as shown in FIG. 5) arranged on one side of the flowing cup 120 so that ozone flows with the treated aquaculture water widely, and the at least one UV light source 320 illuminates the air to produce the ozone in each aquaculture tank 100, thus avoiding proliferation of bacteria and viruses in the treated aquaculture water.

Each water circulating tank 400 is removable and is disposed on a second side of each aquaculture tank 100 proximate to the flowing cup 120. Each water circulating tank 400 includes a nitration reacting chamber 410 defined on a bottom end thereof, an accommodating chamber 420 arranged above the nitration reacting chamber 410, and a stopping layer 430 defined between the nitration reacting chamber 410 and the accommodating chamber 420. The nitration reacting chamber 410 has a flow tube 411 outwardly extending to a bottom end of the flowing cup 120 and has a nitrifying bacteria layer 800 fixed therein.

The nitrifying bacteria layer 800 is filled in a mesh bag and has nitrosomonas and actived carbon which are mixed together, and porous solidified granules made of high polymer, such that the nitrosomonas has high density and maintains in the nitrifying bacteria layer 800 for a long time, thus reducing environmental sensitivity, facilitating solid-liquid separation and sludge elimination, and lowering material consumption (e.g., only extra 20% of nitrifying bacteria layer 800 is refilled ever year).

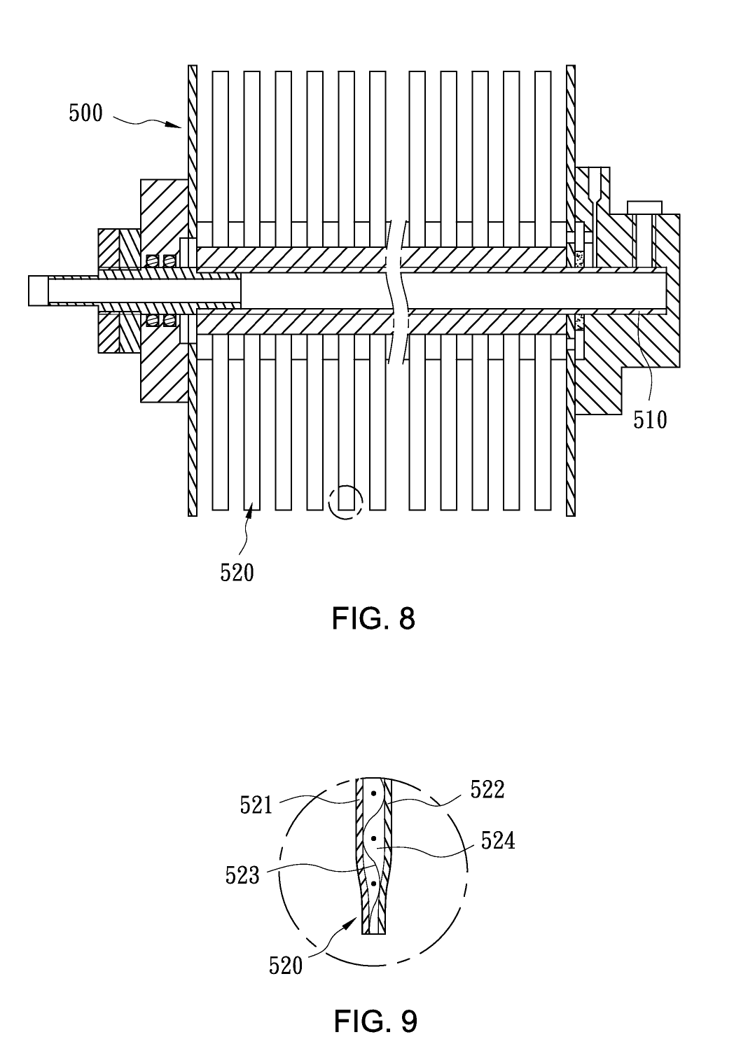

With reference to FIGS. 5 and 8, the plurality of membrane filtering units 500 are parallelly and equidistantly arranged in the accommodating chamber 420, and each membrane filtering unit 500 is a circularly flat membrane and includes a water pipe 510 and plural disc-shaped film bags 520 tightly inserted on the water pipe 510, wherein each film bag 520 has two filtering films 521, 522 and a support net 523 defined between the two filtering films 521, 522, the two filtering films 521, 522 and the support net 523 are one piece welded in a high frequency welding manner, such that a channel 524 (as illustrated in FIG. 9) is formed between the two filtering films 521, 522 and communicates with the water pipe 510. In this embodiment, the two filtering films 521, 522 are a UF membrane disclosed in TW Patent No. 1318133, so further remarks are omitted.

As shown in FIGS. 1, 5 and 7, the water returning unit 600 is fixed outside each aquaculture tank 100 and includes a collecting tube 610 coupled with a distal end of the water pipe 510 of each membrane filtering unit 500 to deliver filtrate water, a pump 620 joined with a distal end of the collecting tube 610, and a water return tube 630 connected with an outlet end of the pump 620. One end of the water return tube 630 is in connection with the suction valve 330 of the sterilization unit 300 so that the ozone is drawn into the treated aquaculture water in the water return tube 630 by ways of the suction valve 330, and then the treated aquaculture water is pumped backed to each aquaculture tank 100, thereby achieving antibacterial and deodorizing effect.

As illustrated in FIGS. 1, 5 and 6, the spraying unit 700 is mounted above the plurality of membrane filtering units 500 and includes a backwash pipe 710 communicating with the water return tube 630 and a controlling valve 720 connecting with the backwash pipe 710, wherein the backwash pipe 710 has a plurality of spray heads 711 for corresponding to the plurality of membrane filtering units 500.

After the aeration unit 200 are actuated by the blower 230, tiny air bubbles are inputted into the treated aquaculture water in each aquaculture tank 100 from an air duct to have air aerating and oxygen dissolving process, and residual feeding and excreta in each aquaculture tank 100 float upwardly and then flow out of each aquaculture tank 100 via the flowing cup 120. Thereafter, the treated aquaculture water flows into the nitration reacting chamber 410 through the flow tube 411 to be nitrified/denitrified by the nitrifying bacteria layer 800, thus removing ammonia, nitrate and nitrite in the treated aquaculture water. In the meantime, a vacuum suction of the pump 620 of the water returning unit 600 drives the treated aquaculture water in the accommodating chamber 420 to be separated into solids and liquids by means of a vacuum pressure difference, and each film bag 520 with 0.03 μm aperture diameter filters viruses, bacteria, sodium hypochlorite, sludge and insoluble solids, then the liquids are pumped back to each aquaculture tank 100 via the water pipe 510, the collecting tube 610, the water return tube 630, and the ozone supply tube 340, thus recycling the treated aquaculture water.

Moreover, the residual feeding and the sludge in the nitration reacting chamber 410 are discharged out of a discharging outlet 440 of each water circulating tank 400 and are concentrate by recycling equipment (such as a pressure filter or a filter) to produce concentrated water as organic fertilizer, and supernatant liquid on the concentrated water is recycled back to a water storage tank.

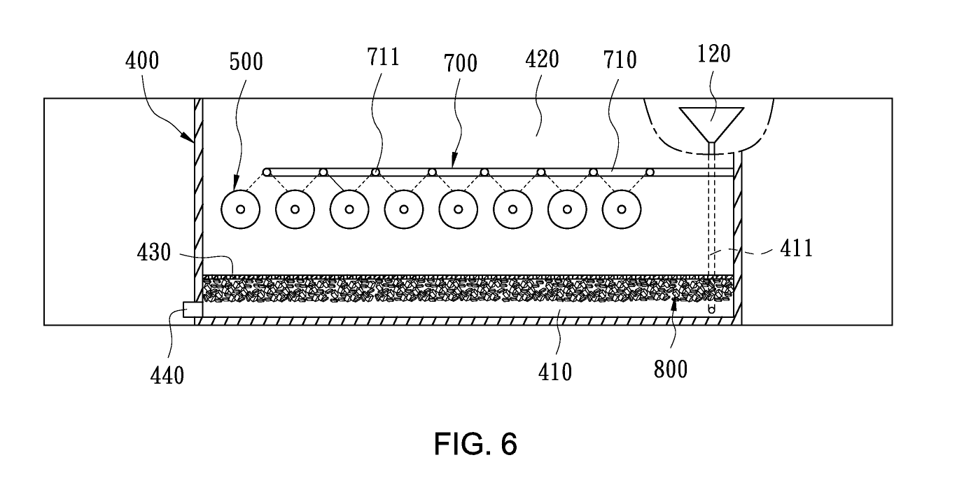

When each film bag 520 attaches the sludge and solid particles, the pump 620 is turned off, and the controlling valve 720 of the spraying unit 700 is started so that the backwash pipe 710 guides recycled water in the water return tube 630, and the plurality of spray heads 711 spray water to clean each film bag 520 as shown in FIG. 6. Preferably, the water for cleaning each film bag 520 is discharged out of the accommodating chamber 420.

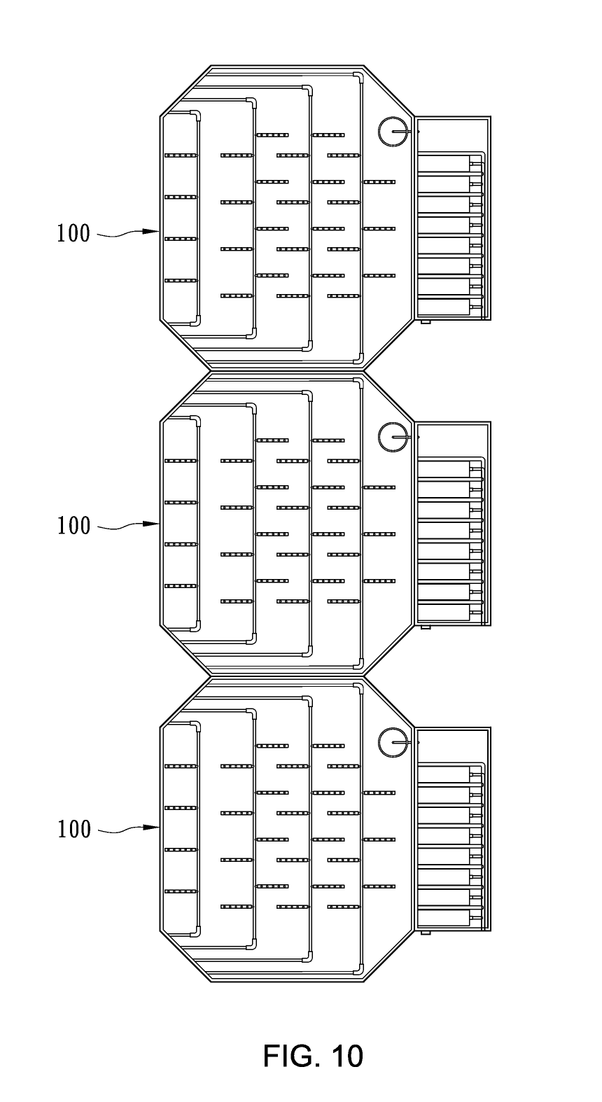

As illustrated in FIG. 10, a plurality of aquaculture tanks 100 (i.e., three aquaculture tanks 100) are connected together to increase aquaculture space.

Accordingly, the water treatment equipment of the present invention has following advantages:

1. The water treatment equipment supplies sufficient dissolved oxygen and flows the residual feeding and the excreta out of each aquaculture tank 100. Preferably, the sterilization unit 300 provides the ozone to avoider the proliferation of bacteria and viruses in the treated aquaculture water, thus enhancing aquaculture density and survival rate.

2. Each aquaculture tank 100 and each water circulating tank 400 are connected quickly by the plural connecting plate units 110 in the predetermined proportion, and they are portable easily.

3. The plural connecting plate units 110 of each aquaculture tank 100 are removable to clean the antibacterial material layer 130, thereby preventing the proliferation of bacteria and viruses.

4. Due to biological treatment and membrane filtering device are integrated in each water circulating tank 400, and each water circulating tank 400 is joined with each aquaculture tank 100, a configuration space of the water treatment equipment is reduced.

5. Each film bag 520 is cleaned periodically to prolong its service life and to save using cost.

6. In denitrifying and membrane filtrating treatment of each water circulating tank 400, only one pump 620 is required, so the treated aquaculture water is pumped backed to each aquaculture tank 100, thereby achieving antibacterial effect and environmental protection.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. Water treatment equipment for recirculating aquaculture comprising:
at least one aquaculture tank, each being removable and including plural connecting plate units connected together to form an octagonal hollow tank, and each aquaculture tank also including a flowing cup;
an aeration unit including a plurality of air supply pipes arranged on a bottom end of each aquaculture tank to input exterior air into water for having aeration, maintaining dissolved oxygen and producing tiny air bubbles, such that residual feeding and excreta in each aquaculture tank float upwardly and then flow out of each aquaculture tank via the flowing cup;
at least one water circulating tank, each being removable and disposed on a first side of each aquaculture tank proximate to the flowing cup, and each water circulating tank including a nitration reacting chamber defined on a bottom end thereof and an accommodating chamber arranged above the nitration reacting chamber, the nitration reacting chamber having a flow tube outwardly extending to the flowing cup and a nitrifying bacteria layer fixed therein, such that the water flows into the nitration reacting chamber through the flow tube to be nitrified/denitrified by the nitrifying bacteria layer, thus removing ammonia, nitrate and nitrite in the water;
a plurality of membrane filtering units arranged in the accommodating chamber, and each membrane filtering unit being a circularly flat membrane and including a water pipe and plural disc-shaped film bags tightly inserted on the water pipe, wherein each film bag has two filtering films communicating with the water pipe; and
a water returning unit fixed outside each aquaculture tank and including a pump joined with one end of the water pipe and a water return tube connected with an outlet end of the pump, the water return tube extending to each aquaculture tank, and the water being pumped backed to each aquaculture tank via the water pipe and the water return tube, thus forming recycled water.

2. The treatment equipment for the recirculating aquaculture as claimed in claim 1, wherein each connecting plate unit has a first plate and a second plate which are manufactured in a predetermined proportion and are coupled together, the aeration unit also includes plural air control valves communicating with the plurality of air supply pipes, each air supply pipe has plural branch pipes extending outwardly from two sides thereof, and each branch pipe has a plurality of air holes.

3. The treatment equipment for the recirculating aquaculture as claimed in claim 2, wherein each of the first plate and the second plate has an antibacterial material layer fixed on an inner wall thereof to enhance antimicrobial effect.

4. The treatment equipment for the recirculating aquaculture as claimed in claim 3, wherein the antibacterial material layer is a stainless steel mesh made of silver, copper, cobalt and titanium dioxide (TiO2), and the antibacterial material layer is removed from each of the first plate and the second plate.

5. The treatment equipment for the recirculating aquaculture as claimed in claim 1 further comprising a sterilization unit mounted for supplying oxygen in the water of each aquaculture tank.

6. The treatment equipment for the recirculating aquaculture as claimed in claim 5, wherein the sterilization unit includes at least one UV light source, a suction valve connecting with the at least one UV light source, and an ozone supply tube extending into the bottom end of each aquaculture tank and communicating with the suction valve, and the ozone supply tube is fixed on a second side of each aquaculture tank away from the flowing cup, thus flowing ozone with the water widely.

7. The treatment equipment for the recirculating aquaculture as claimed in claim 1 further comprising the spraying unit mounted above the plurality of membrane filtering units and including a backwash pipe communicating with the water return tube so as to guide the water to spray each film bag.

8. The treatment equipment for the recirculating aquaculture as claimed in claim 1, wherein the nitrifying bacteria layer is filled in a mesh bag and has nitrosomonas and actived carbon which are mixed together, and porous solidified granules made of high polymer.

9. The treatment equipment for the recirculating aquaculture as claimed in claim 1, wherein each water circulating tank has a discharging outlet.
